(19) United States
(12) Patent Application Publication
(10) Pub. No.: US 2004/0224873 A1
(43) Pub. Date: Nov. 11, 2004

(54) Agent and device and method for producing the same

(76) Inventors: Wilfried Raehse, Duesseldorf (DE); Ovidio Dicoi, Monheim (DE); Rene-Andres Artiga Gonzales, Duesseldorf (DE); Hans-Friedrich Kruse, Korschenbroich (DE); Gerhard Blasey, Duesseldorf (DE)

Correspondence Address: HENKEL CORPORATION, THE TRIAD, SUITE 200, 2200 RENAISSANCE BLVD., GULPH MILLS, PA, 19406, US

(21) Appl. No.: 10/831,955

(22) Filed: Apr. 26, 2004

Related U.S. Application Data
(63) Continuation of application No. PCT/EP02/11623, filed on Oct. 17, 2002.

(30) Foreign Application Priority Data
Oct. 25, 2001 (DE) 101 52 161.8

(51) Int. Cl. C11D 17/00

(52) U.S. Cl. 510/446; 510/452

(57) ABSTRACT

A particulate detergent or cleaning product in the form of a direct spray drying product that has an apparent weight in the range from 220 g/l to 500 g/l and a particle diameter d50 in the range from 0.12 mm to 0.6 mm. Also, a method of producing the particulate product using a spray drying apparatus.

### CROSS REFERENCE TO RELATED APPLICATIONS

This application is a continuation under 35 U.S.C. § 365(c) and 35 U.S.C. § 120 of international application PCT/EP02/11623, filed Oct. 17, 2002. This application also claims priority under 35 U.S.C. § 119 of DE 101 52 161.8, filed Oct. 25, 2001, which is incorporated herein by reference in its entirety.

### BACKGROUND OF THE INVENTION

The present invention relates to a fine-grained detergent or cleaning product, to an apparatus for producing such detergents or cleaning products, and to a method of producing them.

Spray dried detergents or cleaning products have long been known from the prior art. A disadvantage of these compositions is that they normally have a relatively broad grain spectrum, with particle sizes up to above 1000 μm, while at the same time there are also dust fractions with particle sizes below 100 μm. The coarser particles may come about through agglomeration of the primary particles. They can be identified microscopically as particles having raspberrylike structures. Dust fractions, for the known reasons, are not desirable. Normally, however, spray drying products do not only have a very nonuniform grain spectrum; the apparent weight, too, is highly dependent on the grain spectrum. Thus in the past direct spray drying products have generally had an apparent weight of from 200 to 400 g/l. By modifying the spray drying conditions and the ingredients of the compositions to be spray dried it has been possible over the years to obtain higher apparent weights of up to about 600 g/l; by aftertreating the direct spray drying products either with liquid constituents such as nonionic surfactants or by further constructive agglomeration and compaction it has also been possible to achieve higher apparent weights. Where finely divided detergents or cleaning products possibly also still containing dust have been obtained, as a result of the coarser particles being screened off, it has also been possible for these detergents or cleaning products, even without aftertreatment, to have an apparent weight of well above 600 g/l, even of 700 g/l or more, indeed. Finely divided spray drying products having apparent weights below 500 g/l have so far not been disclosed in the art.

Apparatus for the spray drying of solvent-containing compositions, particularly water-containing compositions, is known from the prior art. Frequently used apparatus includes, for example, spraying towers with atomizer nozzles, which are employed in particular with liquid feeds (solutions, suspensions or melts) in order to provide a pulverulent product. In this case the liquid is atomized generally with pressure nozzles and then is dried in a hot gas in cocurrent or countercurrent. The dry product is subsequently separated out using cyclones or filters. Where a melt is atomized and solidified in a cold gas, the tower is referred to as a prilling tower.

Other known spray driers are disk towers. Like the nozzle towers, these are fast driers. For atomization they use rotating disks and are more compact than the nozzle tower. The advantage of the atomizer disk is its insensitivity to clogging of the “nozzles” and to highly variable liquid throughputs.

Also known are spray driers with an integrated fluidized bed. As a result of the incorporation of a fluid bed at the base of the spraying tower it is possible for the product there to be afterdried and classified. The drying gas with the fine dust is drawn off, for example, in the upper section of the tower at the tower head, and the fine dust, following separation, is returned to the tower. Consequently it is also possible to process comparatively tacky and slow-drying feeds. The product obtained comprises readily dispersible agglomerates, which are larger and hence generally less dusty than the powders from the nozzle towers and disk towers.

The spray driers likewise include, in the wider sense, fluid bed spray granulators (“agglomeration driers”), which serve for producing granules in the range from 0.3 mm up to several mm from atomizable solutions, suspensions, and melts. Atomization is performed using two-fluid nozzles. The product is usually abrasion resistant and has a relatively high apparent weight. The dissolution rate is therefore lower as compared with other spraying products. A granulator of this kind can also be used for the coating of granules, in which case it is generally operated batchwise.

WO 92/05849 discloses a process for spray drying valuable substances and mixtures thereof using superheated steam. The use of superheated steam prevents oxidative damage to the drying material.

WO 96/04973 discloses a process for spray drying water-containing valuable-substance preparations from the area of the wetting agents, detergents or cleaning products, which by introducing an auxiliary in the form of a fine or coarse powder into the interior of the spray drying zone prevents instances of caking on the interior wall of the drier.

U.S. Pat No. 5,723,433 describes a method for removing solvents from a pasty surfactant composition, which comprises introducing the pasty composition under pressure into a drying channel and at the inlet of the channel dropping the pressure such that there is a pressure-release evaporation (flash evaporation) of certain components of the pasty composition. The pasty composition is heated in the drying channel and is driven through the channel by the gases which are released in the course of the pressure-release evaporation. The result of the method is a concentrated surfactant paste which is obtained at the outlet of the drying channel.

The known processes for the spray drying of liquid or pasty compositions are disadvantageously characterized by a very high energy consumption. The energy employed is used to a considerable extent not for solvent evaporation but instead for covering heat losses which come about, for example, as a result of the hot offgas.

A further disadvantage is that, in the spray drying of compositions which are susceptible to microbial contamination, the microorganisms present are not reliably exterminated, since in the preparation vessel of the spray drier the compositions are heated generally only for a short time and often only to a temperature of less than 100° C., in order to preserve the substances of value that are present. Even if drying takes place in a very hot gas stream, the particles are exposed to the hot gas only for seconds, which is not enough to exterminate many unwanted microorganisms. This microbial loading is a particular problem in the production of powders or granules which are intended for use in foods, cosmetics or drugs. A complicating factor is that many microorganisms, although they no longer multiply in the dried product in the absence of water, do not die off either, but instead form extremely resistant dormant forms such as spores, for example. Consequently the dried product cannot be identified as contaminated, either by visual or olfactory means; if, however, it is brought into contact with water again—dissolved in water, for example—there may be considerable microbial loadings unless the product is consumed within a few hours.

International patent application WO 99/29830 (EP 0969082) describes finely divided detergents or cleaning products having rapid dissolution kinetics and an average particle diameter of from 150 to 500 μm, with an apparent weight of at least 500 g/l. Essential for the production of these spray dried detergents or cleaning products is that the composition to be spray dried, as well as surfactants which may be present, and inorganic and also, where appropriate, organic builder substances and also, where appropriate, further customary constituents of detergents or cleaning products, also contain, in particular, inorganic ingredients which are not water-soluble. This has the disadvantage that, despite the high dissolution kinetics exhibited by these spray dried products, the normally aqueous application of the products is accompanied by the remanence of water-insoluble constituents, which may deposit on the surfaces to be washed or cleaned.

Accordingly the object of the invention was to provide a fine-grained detergent or cleaning product that does not have these disadvantages. As used herein, the indefinite articles “a” and “an” are synonymous with the phrases “one or more” and “at least one,” unless specifically defined otherwise.

### DESCRIPTION OF THE INVENTION

The invention in a first embodiment therefore provides a fine-grained detergent or cleaning product consisting of a direct spray drying product which has a particle diameter d50 in the range from 0.12 mm to 0.6 mm and has an apparent weight in the range from only 220 g/l to not more than 500 g/l, preferably less than 500 g/l.

Provided in a second embodiment is therefore a fine-grained detergent or cleaning product which is a direct spray drying product and comprises surfactants, inorganic and, where appropriate, organic builder substances, and, where appropriate, further customary ingredients, but where the inorganic constituents present, and the inorganic builder substances in particular, are water-soluble.

In the context of the present invention a direct spray drying product is a product which is obtained by spray drying without further aftertreatment. In particular in respect of the fine division of the product it is pointed out that the stated particle size distributions relate to the direct spray drying product. Here it is particularly advantageous that the composition of the invention exhibits a grain spectrum which is uniform to a relatively high degree, without the need for further customary, prior art aftertreatments such as comminution and/or screening to remove larger constituents and/or dust fractions. In industrial productions such measures always make the process more complex, which generally entails a reduction in product yield and hence an increase in the expense of the product. Moreover, on safety grounds (process safety and health grounds) it is clearly advantageous to minimize dust fractions from the outset in production, instead of having to eliminate them subsequently.

Advantageously, the compositions both after production and after their storage are free flowing, i.e., do not undergo aggregation, and do not form dust. In one preferred embodiment of the invention the free flowing compositions have a score in the aggregation test (for description see later on below) of less than 30, preferably of less than 20, and in particular of less than 10. Especially preferred compositions are those which obtain a score of less than 5 in the aggregation test.

In one embodiment of the invention the particle diameter d50 of a sieve analysis, based on % by weight, of the direct spray drying products is in the range from 0.12 mm, preferably from 0.14 mm, to 0.6 mm. Particular preference is given in this context, in particular, to particle diameters d50 in the range from 0.17 mm to 0.4 mm, with further preference being given to particle sizes d50 of from 0.19 to 0.28 mm. Of particular advantage in this context are direct spray drying products which to the extent of at least 90% by weight have a particle size (d90) of from 0.3 mm to 0.8 mm and preferably from 0.35 mm to 0.55 mm. Particular preference here is given to direct spray drying products which to an extent of not more than 10% by weight have a particle size (d10) of not more than 0.2 mm, in particular in the range from 0.12 to 0.18 mm. Finally of particular desirability, for the reasons stated, are direct spray drying products which to an extent of not more than 5% by weight have a particle size below 0.1 mm.

The apparent weights of the compositions of the invention can vary within a broad spectrum. It is preferred, however, for the apparent weights of the direct spray drying products to be in a range from 220 g/l to 500 g/l, particular preference being given to a range from 250 g/l to 480 g/l: for example, of 270 g/l or more. Apparent weights in the range from 300 to 450 g/l are once again to be regarded as particularly preferred. Particular advantages attach in this context to direct spray drying products which to an extent of more than 90% by weight and in particular more than 95% by weight are composed of particles having a size below 0.8 mm and to an extent of not more than 4% by weight are composed of particles below 0.1 mm.

Anionic surfactants used are, for example, those of the sulfonate and sulfate type. Preferred surfactants of the sulfonate type are C₉₋₁₃ alkylbenzenesulfonates, olefinsulfonates, i.e., mixtures of alkenesulfonates and hydroxyalkanesulfonates, and also disulfonates, as are obtained, for example, from C₁₂₋₁₈ monoolefins having a terminal or internal double bond by sulfonation with gaseous sulfur trioxide followed by alkaline or acidic hydrolysis of the sulfonation products. Also suitable are alkanesulfonates, which are obtained from C₁₂₋₁₈ alkanes, for example, by sulfochlorination or sulfoxidation with subsequent hydrolysis or neutralization, respectively. Likewise suitable, in addition, are the esters of α-sulfo fatty acids (ester sulfonates), e.g., the α-sulfonated methyl esters of hydrogenated coconut, palm kernel or tallow fatty acids.

Further suitable anionic surfactants are sulfated fatty acid glycerol esters. Fatty acid glycerol esters are the monoesters, diesters and triesters, and mixtures thereof, as obtained in the preparation by esterification of a monoglycerol with from 1 to 3 mol of fatty acid or in the transesterification of triglycerides with from 0.3 to 2 mol of glycerol. Preferred sulfated fatty acid glycerol esters are the sulfation products of saturated fatty acids having 6 to 22 carbon atoms, examples being those of caproic acid, caprylic acid, capric acid, myristic acid, lauric acid, palmitic acid, stearic acid, or behenic acid.

Preferred alk(en)yl sulfates are the alkali metal salts, and especially the sodium salts, of the sulfuric monoesters of C₁₂-C₁₈ fatty alcohols, examples being those of coconut fatty alcohol, tallow fatty alcohol, lauryl, myristyl, cetyl or stearyl alcohol, or of C₁₀-C₂₀ oxo alcohols, and those of monoesters of secondary alcohols of these chain lengths. Preference is also given to alk(en)yl sulfates of said chain length which contain a synthetic straight-chain alkyl radical prepared on a petrochemical basis, these sulfates possessing degradation properties similar to those of the corresponding compounds based on fatty-chemical raw materials. From a detergents standpoint, the C₁₂-C₁₆ alkyl sulfates and C₁₂-C₁₅ alkyl sulfates, and also C₁₄-C₁₅ alkyl sulfates, are preferred. In addition, 2,3-alkyl sulfates, which may be obtained as commercial products from Shell Oil Company under the name DAN®, are suitable anionic surfactants.

Also suitable are the sulfuric monoesters of the straight-chain or branched C₇₋₂₁ alcohols ethoxylated with from 1 to 6 mol of ethylene oxide, such as 2-methyl-branched C₉₋₁₁ alcohols containing on average 3.5 mol of ethylene oxide (EO) or C₁₂₋₁₈ fatty alcohols containing from 1 to 4 EO. Because of their high foaming behavior they are used in cleaning products only in relatively small amounts: for example, in amounts of from 1 to 5% by weight.

Further suitable anionic surfactants include the salts of alkylsulfosuccinic acid, which are also referred to as sulfosuccinates or as sulfosuccinic esters and which constitute monoesters and/or diesters of sulfosuccinic acid with alcohols, preferably fatty alcohols and especially ethoxylated fatty alcohols. Preferred sulfosuccinates comprise C₈₋₁₈ fatty alcohol radicals or mixtures thereof. Especially preferred sulfosuccinates contain a fatty alcohol radical derived from ethoxylated fatty alcohols which themselves represent nonionic surfactants (for description see below). Particular preference is given in turn to sulfosuccinates whose fatty alcohol radicals are derived from ethoxylated fatty alcohols having a narrowed homolog distribution. Similarly it is also possible to use alk(en)ylsuccinic acid containing preferably 8 to 18 carbon atoms in the alk(en)yl chain, or salts thereof.

The amount of the stated anionic surfactants in the direct spray drying products is preferably from 2 to 30% by weight and in particular from 5 to 25% by weight, particular preference being given to concentrations above 10% by weight and even above 15% by weight.

In addition to the stated anionic surfactants it is possible for soaps to be present. Particularly suitable soaps include saturated fatty acid soaps, such as the salts of lauric acid, myristic acid, palmitic acid, stearic acid, hydrogenated erucic acid and behenic acid, and, in particular, mixtures of soaps derived from natural fatty acids, e.g., coconut, palm kernel, or tallow fatty acids. The amount of soaps in the direct spray drying products is preferably not more than 3% by weight and in particular from 0.5 to 2.5% by weight.

The anionic surfactants and/or soaps may be present in the form of their sodium, potassium or ammonium salts and also as soluble salts of organic bases, such as mono-, di- or triethanolamine. Preferably they are in the form of their sodium or potassium salts, in particular in the form of the sodium salts. Anionic surfactants and soaps can also be prepared in situ, by introducing into the composition to be spray dried the anionic surfactant acids and, where appropriate, fatty acids, which are then neutralized by the alkali carriers in the composition to be spray dried.

Nonionic surfactants are normally present only in minor amounts—if at all—in direct spray dried products. Their amount, for example, can be up to 2 or 3% by weight. For a more precise description of the nonionic surfactants, reference is made to the description of the aftertreated spray drying products later on below.

Further ingredients of the direct spray drying product are inorganic and, where appropriate, organic builder substances. The inorganic builder substances also include ingredients which are not water-insoluble such as aluminosilicates and, in particular, zeolites. The finely crystalline, synthetic zeolite used, containing bound water, is preferably zeolite A and/or P. A particularly preferred zeolite P is, for example, Zeolite MAP® (commercial product from Crosfield). Also suitable, however, are zeolite X and also mixtures of A, X and/or P. Also of particular interest is a cocrystallized sodium/potassium aluminum silicate of zeolite A and zeolite X, which is available commercially as VEGOBOND AX® (commercial product from Condea Augusta S.p.A.). This product is described in more detail below. The zeolite can be employed as a spray dried powder or else as an undried, stabilized suspension still wet from its preparation. Where the zeolite is used as suspension it is possible for said suspension to include small additions of nonionic surfactants as stabilizers: for example, from 1 to 3% by weight, based on zeolite, of ethoxylated C₁₂-C₁₈ fatty alcohols having 2 to 5 ethylene oxide groups, C₁₂-C₁₄ fatty alcohols having 4 to 5 ethylene oxide groups or ethoxylated isotridecanols. Suitable zeolites have an average particle size of less than 10 μm (volume distribution; measurement method: Coulter counter) and contain preferably from 18 to 22% by weight, in particular from 20 to 22% by weight, of bound water.

Further particularly suitable zeolites include zeolites of the faujasite type. Together with zeolites X and Y, the mineral faujasite is one of the faujasite types within zeolite structural group 4 which are characterized by the double six-membered ring subunit D6R (compare Donald W. Breck: “Zeolite Molecular Sieves”, John Wiley & Sons, New York, London, Sydney, Toronto, 1974, page 92). In addition to said faujasite types, zeolite structural group 4 includes the mineral chabazite and gmelinite and also the synthetic zeolites R (chabazite type), S (gmelinite type), L, and ZK-5. The two last-mentioned synthetic zeolites have no mineral analogs.

Zeolites of the faujasite type are composed of β cages linked tetrahedrally via D6R subunits, the β cages being arranged similarly to the carbon atoms in a diamond. The three-dimensional network of the faujasite-type zeolites suitable in accordance with the invention has pores of 2.2 and 7.4 Å; the unit cell further contains 8 cavities of approximately 13 Å in diameter and may be described by the formula Na₈₆[(AlO₂)₈₆(SiO₂)₁₀₆]·264 H₂0. The network of zeolite X contains a cavity volume of approximately 50%, based on the dehydrated crystal, which represents the greatest empty space of all known zeolites (zeolite Y: approx. 48% cavity volume; faujasite: approx. 47% cavity volume). (All data from: Donald W. Breck: “Zeolite Molecular Sieves”, John Wiley & Sons, New York, London, Sydney, Toronto, 1974, pages 145, 176, 177.)

In the context of the present invention, the term “faujasite-type zeolite” characterizes all three zeolites which form the faujasite subgroup of zeolite structural group 4. In accordance with the invention, therefore, not only zeolite X but also zeolite Y and faujasite, and mixtures of these compounds, are suitable, preference being given to straight zeolite X.

Also suitable in accordance with the invention are mixtures or cocrystallizates of faujasite-type zeolites with other zeolites, which need not necessarily belong to zeolite structural group 4, with preferably at least 50% by weight of the zeolites being faujasite-type zeolites.

The suitable aluminum silicates are available commercially and the methods of preparing them are described in standard monographs.

Examples of commercially available zeolites of the X type may be described by the following formulae:

Na₈₆[(AlO₂)₈₆(SiO₂)₁₀₆]·x H₂O

K₈₆[(AlO₂)₈₆(SiO₂)_{106]·x H}₂O

Ca₄₀Na₆[(AlO₂)₈₆(SiO₂)_{106]·x H}₂O

Sr₂₁Ba₂₂[AlO₂)₈₆(SiO₂)_{106]·x H}₂O

where x may adopt values between 0 and 276. These zeolites have pore sizes of from 8.0 to 8.4 Å.

Also suitable, for example, is the zeolite A-LSX described in European patent application EP-A-816 291, which corresponds to a cocrystallizate of zeolite X and zeolite A and in its anhydrous form possesses the formula (M_{2/n}O+M′_{2/n}O)·Al₂O₃·zSiO₂, where M and M′ can be alkali metals or alkaline earth metals and z is a number between 2.1 and 2.6. This product is available commercially under the brand name VEGOBOND AX from CONDEA Augusta S.p.A.

Zeolites of the Y type are also available commercially and may be described, for example, by the formulae

Na₅₆[(AlO₂)₅₆(SiO₂)₁₃₆]·x H₂O

K₅₆[(AlO₂)₅₆(SiO₂)₁₃₆]·x H₂O

where x is a number between 0 and 276. These zeolites have pore sizes of 8.0 Å.

The particle sizes of the suitable faujasite-type zeolites lie in the range from 0.1 up to 100 μm, preferably between 0.5 and 50 μm, and in particular between 1 and 30 μm, in each case measured by standard particle size determination methods.

In one preferred embodiment of the invention, however, the compositions comprise not only an inorganic builder but also a builder system which comprises one or more inorganic and/or organic builders and/or cobuilders. This builder system is preferably of predominantly water-soluble nature. For the purposes of the present invention this means that at least 50% by weight of all of the builders and/or cobuilders used, but advantageously at least 60% by weight, and in particular at least 70% by weight of the builder system, are water-soluble. Very particular preference is given to direct spray drying products which comprise a builder system containing from 75 to 100% by weight of water-soluble builders and cobuilders.

In another fundamental embodiment of the invention indeed all of the inorganic constituents present are of water-soluble nature. In these embodiments, therefore, builder substances other than the zeolites already mentioned are used. In this embodiment of the invention as well preference is given to builder systems comprising inorganic and/or organic builders and/or cobuilders.

It is particularly preferred for the compositions of the invention to comprise at least one inorganic builder and at least one organic builder. It is further preferred for the compositions of the invention to comprise at least 2 different inorganic builders and also, optionally, at least one organic cobuilder.

In cases where a phosphate content is tolerated it is also possible to use phosphates, especially pentasodium triphosphate, and possibly also pyrophosphates, and orthophosphates, which act primarily as precipitants for lime salts. Phosphates are used predominantly in machine dishwashing detergents but in some cases also in laundry detergents as well.

Alkali metal phosphates is the collective term for the alkali metal (especially sodium and potassium) salts of the various phosphoric acids, among which metaphosphoric acids (HPO₃)ₙ and orthophosphoric acid H₃PO₄, in addition to higher-molecular-mass representatives, may be distinguished. The phosphates combine a number of advantages: they act as alkali carriers, prevent limescale deposits on machine components, and lime incrustations in fabrics, and additionally contribute to cleaning performance.

Sodium dihydrogen phosphate, NaH₂PO₄, exists as the dihydrate (density 1.91 g cm⁻³, melting point 60°) and as the monohydrate (density 2.04 g cm^{31 3}). Both salts are white powders of very ready solubility in water which lose the water of crystallization on heating and undergo conversion at 200° C. into the weakly acidic diphosphate (disodium dihydrogen diphosphate, Na₂H₂P₂O₇) and at the higher temperature into sodium trimetaphosphate (Na₃P₃O₉) and Maddrell's salt (see below). NaH₂PO₄ reacts acidically; it is formed if phosphoric acid is adjusted to a pH of 4.5 using sodium hydroxide solution and the slurry is sprayed. Potassium dihydrogen phosphate (primary or monobasic potassium phosphate, potassium biphosphate, PDP), KH₂PO₄, is a white salt with a density of 2.33 g cm^{31 3}, has a melting point of 253° [decomposition with formation of potassium polyphosphate (KPO₃)ₓ], and is readily soluble in water.

Disodium hydrogen phosphate (secondary sodium phosphate), Na₂HPO₄, is a colorless, crystalline salt which is very readily soluble in water. It exists in anhydrous form and with 2 mol (density 2.066 g cm^{31 3}, water loss at 95°), 7 mol (density 1.68 g cm^{31 3}, melting point 48° with loss of 5 H₂O), and 12 mol of water (density 1.52 g cm^{31 3}, melting point 35° with loss of 5 H₂O), becomes anhydrous at 100°, and if heated more severely undergoes transition to the diphosphate Na₄P₂O₇. Disodium hydrogen phosphate is prepared by neutralizing phosphoric acid with sodium carbonate solution using phenolphthalein as indicator. Dipotassium hydrogen phosphate (secondary or dibasic potassium phosphate), K₂HPO₄, is an amorphous white salt which is readily soluble in water.

Trisodium phosphate, tertiary sodium phosphate, Na₃PO₄, are colorless crystals which as the dodecahydrate have a density of 1.62 g cm⁻³ and a melting point of 73-76° C. (decomposition), as the decahydrate (corresponding to 19-20% P₂O₅) have a melting point of 100° C., and in anhydrous form (corresponding to 39-40% P₂O₅) have a density of 2.536 g cm⁻³. Trisodium phosphate is readily soluble in water, with an alkaline reaction, and is prepared by evaporative concentration of a solution of precisely 1 mol of disodium phosphate and 1 mol of NaOH. Tripotassium phosphate (tertiary or tribasic potassium phosphate), K₃PO₄, is a white, deliquescent, granular powder of density 2.56 g cm⁻³, has a melting point of 1340°, and is readily soluble in water with an alkaline reaction. It is produced, for example, when Thomas slag is heated with charcoal and potassium sulfate. Despite the relatively high price, the more readily soluble and therefore highly active potassium phosphates are frequently preferred in the cleaning products industry over corresponding sodium compounds.

Tetrasodium diphosphate (sodium pyrophosphate), Na₄P₂O₇, exists in anhydrous form (density 2.534 g cm⁻³, melting point 988°, 880° also reported) and as the decahydrate (density 1.815-1.836 g cm⁻³, melting point 94° with loss of water). Both substances are colorless crystals which dissolve in water with an alkaline reaction. Na₄P₂O₇ is formed when disodium phosphate is heated at >200° or by reacting phosphoric acid with sodium carbonate in stoichiometric ratio and dewatering the solution by spraying. The decahydrate complexes heavy metal salts and water hardeners and therefore reduces the hardness of the water. Potassium diphosphate (potassium pyrophosphate), K₄P₂O₇, exists in the form of the trihydrate and is a colorless, hygroscopic powder of density 2.33 g cm⁻³ which is soluble in water, the pH of the 1% strength solution at 25° being 10.4.

Condensation of NaH₂PO₄ or of KH₂PO₄ gives rise to higher-molecular-mass sodium and potassium phosphates, among which it is possible to distinguish cyclic representatives, the sodium and potassium metaphosphates, and catenated types, the sodium and potassium polyphosphates. For the latter in particular a large number of names are in use: fused or calcined phosphates, Graham's salt, Kurrol's and Maddrell's salt. All higher sodium and potassium phosphates are referred to collectively as condensed phosphates.

The industrially important pentasodium triphosphate, Na₅P₃O₁₀ (sodium tripolyphosphate), is a nonhygroscopic, white, water-soluble salt which is anhydrous or crystallizes with 6 H₂O and has the general formula NaO—[P(O)(ONa)—O]ₙ—Na where n=3. About 17 g of the anhydrous salt dissolve in 100 g of water at room temperature, at 60° about 20 g, at 100° around 32 g; after heating the solution at 100° C. for two hours, about 8% orthophosphate and 15% diphosphate are produced by hydrolysis. For the preparation of pentasodium triphosphate, phosphoric acid is reacted with sodium carbonate solution or sodium hydroxide solution in stoichiometric ratio and the solution is dewatered by spraying. In a similar way to Graham's salt and sodium diphosphate, pentasodium triphosphate dissolves numerous insoluble metal compounds (including lime soaps, etc). Pentapotassium triphosphate, K₅P₃O₁₀ (potassium tripolyphosphate), is commercialized, for example, in the form of a 50% strength by weight solution (>23% P₂O₅, 25% K₂O). The potassium polyphosphates find broad application in the laundry detergents and cleaning products industry. There also exist sodium potassium tripolyphosphates, which may likewise be used for the purposes of the present invention. These are formed, for example, when sodium trimetaphosphate is hydrolyzed with KOH:

(NaPO₃)₃+2KOH→Na₃K₂P₃O₁₀+H₂O

They can be used in accordance with the invention in precisely the same way as sodium tripolyphosphate, potassium tripolyphosphate, or mixtures of these two; mixtures of sodium tripolyphosphate and sodium potassium tripolyphosphate, or mixtures of potassium tripolyphosphate and sodium potassium tripolyphosphate, or mixtures of sodium tripolyphosphate and potassium tripolyphosphate and sodium potassium tripolyphosphate, may also be used in accordance with the invention.

In one preferred embodiment of the invention, however, carbonates and silicates are used in particular as inorganic builder substances.

Mention should be made here in particular of crystalline, layered sodium silicates possessing the general formula NaMSiₓO₂ₓ₊₁.yH₂O, where M is sodium or hydrogen, x is a number from 1.6 to 4, preferably from 1.9 to 4, y is a number from 0 to 20, and preferred values for x are 2, 3 or 4. Since, however, crystalline silicates of this kind lose their crystalline structure, at least partly, in a spray drying process, crystalline silicates are preferably admixed subsequently to the direct or aftertreated spray drying product. Crystalline phyllosilicates of this kind are described, for example, in European patent application EP-A-0 164 514. Preferred crystalline phyllosilicates of the formula indicated are those in which M is sodium and x adopts the value 2 or 3. In particular, both β- and δ-sodium disilicates Na₂Si₂O₅.yH₂O are preferred. Compounds of this kind are in commerce, for example, under the designation SKS® (Clariant). Thus in the case of SKS-6® the product is predominantly a δ-sodium disilicate with the formula Na₂Si₂O₅.yH₂O; SKS-7® is predominantly the β-sodium disilicate. Reaction with acids (e.g., citric acid or carbonic acid) produces from the δ-sodium disilicate kanemite NaHSi₂O₅.yH₂O, in commerce under the designations SKS-9® and SKS-10® (Clariant), respectively. It may also be of advantage to use chemical modifications of these phyllosilicates. For example, the alkalinity of the phyllosilicates can be influenced appropriately. As compared with δ-sodium disilicate, phosphate-doped and/or carbonate-doped phyllosilicates have altered crystal morphologies, dissolve more rapidly, and exhibit a calcium-binding power which is higher than that of δ-sodium disilicate. Thus phyllosilicates of the general empirical formula x Na₂OΦy SiO₂•z P₂O₅, in which the ratio of x to y corresponds to a number from 0.35 to 0.6, the ratio of x to z corresponds to a number from 1.75 to 1200, and the ratio of y to z corresponds to a number of from 4 to 2800, are described in patent application DE-A-196 01 063. The solubility of the phyllosilicates can also be increased, by using particularly finely divided phyllosilicates. Compounds of the crystalline phyllosilicates with other ingredients can be used as well. Mention may be made in particular in this context of compounds with cellulose derivatives, which have advantages in the disintegrating effect, and compounds with polycarboxylates, e.g., citric acid, and/or polymeric polycarboxylates, e.g., copolymers of acrylic acid.

The preferred builder substances also include amorphous sodium silicates having an Na₂O:SiO₂ modulus of from 1:2 to 1:3.3, preferably from 1:2 to 1:2.8, and in particular from 1:2 to 1:2.6, which are dissolution-retarded and have secondary washing properties. The retardation of dissolution relative to conventional amorphous sodium silicates may have been brought about in a variety of ways—for example, by surface treatment, compounding, compacting, or overdrying. In the context of this invention, the term “amorphous” also embraces “X-ray-amorphous”. This means that in X-ray diffraction experiments the silicates do not yield the sharp X-ray reflections typical of crystalline substances but instead yield at best one or more maxima of the scattered X-radiation, having a width of several degree units of the diffraction angle. However, good builder properties may result, very probably even particularly good builder properties, if the silicate particles in electron diffraction experiments yield vague or even sharp diffraction maxima. The interpretation of this is that the products have microcrystalline regions with a size of from 10 to several hundred nm, values up to max. 50 nm and in particular up to max. 20 nm being preferred. So-called X-ray-amorphous silicates of this kind, which likewise possess retarded dissolution relative to the conventional waterglasses, are described, for example, in German patent application DE-A-44 00 024. Particular preference is given to compacted amorphous silicates, compounded amorphous silicates, and overdried X-ray-amorphous silicates. The amount of the (X-ray-)amorphous silicates in the zeolite-free direct spray drying products is preferably from 1 to 10% by weight.

Particularly preferred inorganic water-soluble builders, however, are alkali metal carbonates and alkali metal bicarbonates, alone or in combination with sesquicarbonates, with the preferred embodiments including sodium and potassium carbonate and, in particular, sodium carbonate. Of particular advantage are compositions which comprise sodium carbonate and sodium bicarbonate. The amount of the alkali metal carbonates and/or of the alkali metal bicarbonates in the particularly zeolite-free direct spray drying products can vary within a very broad spectrum and is preferably from 5 to 40% by weight, in particular from 8 to 30% by weight, with the amount of alkali metal carbonates and/or of alkali metal bicarbonates usually being higher than that of amorphous silicates.

Organic builder substances which may be used are, for example, the polycarboxylic acids, usable in the form of their sodium salts, the term polycarboxylic acids meaning those carboxylic acids which carry more than one acid function. Examples of these are citric acid, adipic acid, succinic acid, glutaric acid, malic acid, tartaric acid, maleic acid, fumaric acid, sugar acids, amino carboxylic acids, nitrilotriacetic acid (NTA), provided such use is not objectionable on ecological grounds, and also mixtures thereof. Preferred salts are the salts of the polycarboxylic acids such as citric acid, adipic acid, succinic acid, glutaric acid, tartaric acid, methylglycinediacetic acid, sugar acids, and mixtures thereof.

The acids per se may also be used. In addition to their builder effect, the acids typically also possess the property of an acidifying component and thus also serve to establish a lower and milder pH of laundry detergents or cleaning products. In this context, mention may be made in particular of citric acid, succinic acid, glutaric acid, adipic acid, gluconic acid, and any desired mixtures thereof.

Also suitable as organic cobuilders are polymeric poly-carboxylates; these are, for example, the alkali metal salts of polyacrylic acid or of polymethacrylic acid, examples being those having a relative molecular mass of from 500 to 70 000 g/mol.

The molecular masses reported for polymeric polycarboxylates, for the purposes of this document, are weight-average molecular masses, M_{w}, of the respective acid form, determined basically by means of gel permeation chromatography (GPC) using a UV detector. The measurement was made against an external polyacrylic acid standard, which owing to its structural similarity to the polymers under investigation provides realistic molecular weight values. These figures differ markedly from the molecular weight values obtained using poly-styrenesulfonic acids as the standard. The molecular masses measured against polystyrenesulfonic acids are generally much higher than the molecular masses reported in this document.

Suitable polymers are, in particular, polyacrylates, which preferably have a molecular mass of from 1000 to 20 000 g/mol. Owing to their superior solubility, preference in this group may be given in turn to the short-chain polyacrylates, which have molecular masses of from 1000 to 10 000 g/mol, and with particular preference from 1200 to 8000 g/mol, 2000 or 8000, for example, and in particular from 3000 to 5000.

With particular preference use is made in the compositions of the invention not only of polyacrylates but also of copolymers of unsaturated carboxylic acids, monomers containing sulfonic acid groups, and, if desired, further ionic or nonionogenic monomers. The copolymers containing sulfonic acid groups are described at length below.

Also suitable are copolymeric polycarboxylates, especially those of acrylic acid with methacrylic acid and of acrylic acid or methacrylic acid with maleic acid. Copolymers which have been found particularly suitable are those of acrylic acid with maleic acid which contain from 50 to 90% by weight acrylic acid and from 50 to 10% by weight maleic acid. Their relative molecular mass, based on free acids, is generally from 2000 to 100 000 g/mol, preferably from 20 000 to 90 000 g/mol, and in particular from at least 30 000 to 80 000 g/mol, with polymers of this kind having relative molecular masses of up to 70 000 g/l, up to 50 000 g/l or from 30 000 to 40 000 g/l also being suitable.

The amount of organic builder substances in the direct spray drying products may likewise vary within a broad spectrum. Preference is given to amounts of from 2 to 20% by weight; on the grounds of cost in particular, amounts of not more than 10% by weight are particularly well received.

From the remaining groups of customary laundry detergent constituents suitability for use in connection with the spray drying of the invention, and in particular by means of the apparatus of the invention, is possessed in particular by components in the classes of the graying inhibitors (soil carriers), the neutral salts, and the textile softener auxiliaries.

The function of graying inhibitors is to keep the soil detached from the fiber in suspension in the liquor and so to prevent redeposition of the soil. Suitability for this purpose is possessed by water-soluble colloids, usually organic in nature, examples being the water-soluble salts of polymeric carboxylic acids, size, gelatin, salts of ethercarboxylic acids or ethersulfonic acids of starch or of cellulose, or salts of acidic sulfuric esters of cellulose or of starch. Water-soluble polyamides containing acidic groups are also suitable for this purpose. Additionally it is possible to use soluble starch preparations and starch products other than those mentioned above, e.g., degraded starch, aldehyde starches, and so on. Polyvinylpyrrolidone as well can be used. Preference, however, is given to employing cellulose ethers, such as carboxymethylcellulose (Na salt), methylcellulose, hydroxyalkylcellulose, and mixed ethers, such as methylhydroxyethylcellulose, methylhydroxypropylcellulose, methylcarboxymethylcellulose, and mixtures thereof, and also polyvinylpyrrolidone, in amounts, for example, of from 0.1 to 5% by weight, based on the compositions.

A typical example of a suitable representative of the neutral salts is the compound sodium sulfate already mentioned. It can be used in amounts of, for example, from 2 to 45% by weight.

Examples of suitable softeners are swellable phyllosilicates of the type of corresponding montmorillonites, bentonite for example.

The amount of water in the direct spray drying product is preferably from 0 to less than 10% by weight and in particular from 0.5 to 8% by weight, with values of not more than 5% by weight finding particular preference. These values do not include the water adhering to any aluminosilicates present such as zeolite.

The direct spray drying products of the invention do not only have an outstanding free-flow behavior; the aggregation test, too, is regularly passed with very good scores (for description of the tests see below).

For instance, a direct spray drying product of the invention with an apparent weight of 420 g/l, a water content of 2.2% by weight, a particle size distribution which looked as follows (sieve analysis):>1.6 mm 0% by weight, to 0.8 mm 1% by weight, to 0.4 mm 24% by weight, to 0.2 mm 47% by weight, to 0.1 mm 25% by weight, and there below 3% by weight, and a whiteness Y of 97.6% gave a “0” in the aggregation test, not only directly after production but also after storage (8 weeks' storage at 23° C. and 50% humidity).

A further feature of the compositions of the invention is that they have a relatively high dry residue. Thus the dry residue is preferably from 94.5 to 99.8% and in particular from 95.2 to 99.2%, with compositions having dry residues of from 96.0 to 98.5% being regarded as particularly advantageous. (For description of the determination of the dry residue see below).

The invention further provides a method of producing the compositions of the invention. In this method a liquid or pasty, solvent-containing, in particular water-containing, composition is heated to a temperature above the boiling point of the solvent, particularly water, the heated liquid or pasty, solvent-containing, particularly water-containing composition is supplied to an atomizing device under overpressure and at a temperature above the boiling point of the solvent, particularly water, and the heated liquid or pasty, solvent-containing, particularly water-containing, composition, under overpressure and at a temperature above the boiling point of the solvent, particularly water, is atomized by means of the atomizing device into a relaxation space, which is not under overpressure. The liquid to pasty, solvent-containing and particularly water-containing composition is heated by direct input of heat, indirect input of heat or by a combination of both. In contrast to conventional spray drying processes, in which slurry temperatures had usually been set to not more than about 80° C., the composition in the method of the invention is heated preferably to above 100° C., in particular to at least 130° C., and with particular preference to at least 160° C.

A method of this kind is described in the German patent application, unpublished at the priority date of the present specification but now a granted German patent, DE 100 21 539, and international patent application WO 01/83071, the content of which is expressly incorporated by reference at this point. In accordance with the invention it is particularly preferred to carry out the method using a spray drying apparatus which comprises

a) a feedline for a liquid or pasty, solvent-containing, particularly water-containing, composition,

b) means for heating the liquid or pasty, solvent-containing, particularly water-containing, composition to a temperature above the boiling point of the solvent, the input of heat taking place directly, indirectly or by combination of direct or indirect means,

c) means for transporting the liquid or pasty, solvent-containing, particularly water-containing, composition, heated in b), under overpressure and at a temperature above the boiling point of the solvent,

d) means for atomizing the liquid or pasty, solvent-containing, particularly water-containing, composition heated in b) and transported under overpressure in c), at a temperature above the boiling point of the solvent, particularly water, and

e) a relaxation space which is not under overpressure, and which accommodates the composition atomized by means of d).

The energy consumption of this apparatus for a given drying performance is advantageously lower than that of conventional spray driers. The energy saving is generally from about 10% to about 35%. Moreover, as a result of transport and atomization under overpressure, there is substantial pressure sterilization of the composition to be dried, particularly if the suspension is heated above 150° C. When atomization under overpressure takes place into the relaxation space which is not under overpressure there is a pressure-release evaporation of the solvent or at least of fractions of the solvent. In the pressure-release evaporation (flash evaporation) a liquid material stream is brought to a lower pressure. In the course of this, some of the liquid evaporates, and in doing so cools; in other words, the evaporation enthalpy required for the evaporation process is in this case taken from the remaining liquid and not supplied from the outside. In detail, the pressure-release evaporation process can be conceived as being one in which, following the lowering of the pressure, first of all a large number of very small vapor bubbles is formed in the liquid. The quantity of vapor then grows until, given a sufficient residence time in the pressure-release vessel, the thermodynamic equilibrium is reached: in other words, at atmospheric pressure, a vapor temperature and droplet temperature of 100° C. is established.

A multiplicity of gases can be used as drying gases. For the purposes of the present invention, however, preference is given to air and air/flue gas mixtures, nitrogen and/or superheated steam. In the drying stage a dry residue of preferably from 94.5 to 99.8% and in particular from 95.2 to 99.2% is attained. Particular preference is given to the setting of a dry residue of from 96.0 to 98.5%.

The rapid pressure drop has an additional sterilizing effect, since it destroys the cell membranes and/or cell walls of microorganisms that are still intact, thereby exterminating them.

A further, surprising positive effect which is observed when the method of the invention is employed is the increase in what is called the Berger wideness in the drying of detergents, wetting agents or cleaning products, by about 20% to about 70%, generally by about 50%, as compared with conventionally spray dried products.

A liquid or pasty, solvent-containing composition for the purposes of the present invention can be any appropriate solution, dispersion or combination of solution and dispersion of a solid in the solvent. In particular, in the method of the invention, use is made of liquid or pasty, water-containing compositions, which are subjected to pressure-release evaporation in a spray drier.

As means b) of the apparatus it is possible in the method of the invention to use basically any heat source capable of heating the liquid or pasty, solvent-containing, especially water-containing, composition to a temperature above the boiling point of the solvent, particularly water. Thus the introduction of heat may take place directly, indirectly or by a combination of the two methods. Suitable indirect heat sources are—as disklosed in German patent DE 100 21 539—gas burners, radiant heaters or, in particular, heat exchangers, for example.

In the case of direct introduction of heat it is advantageous for heating b) to use steam under pressure, the apparatus of the invention and apparatus used in accordance with the invention providing a means for the direct introduction of the pressurized steam, As means for the direction introduction of the pressurized steam preference is given in particular to a means that operates in accordance with the Venturi principle, such as a Venturi tube or Venturi nozzle. In one preferred embodiment of the invention the direct introduction of the steam takes place with a steam pressure of from 20 to 75 bar.

Both heat exchangers and the direct introduction of pressurized steam, as alternatives for the heat source b), constitute particularly preferred embodiments. In certain embodiments of the invention, however, it has proven particularly advantageous to use pressurized steam instead of the heat exchanger. This is the case particularly when the composition to be spray dried contains relatively large amounts of ingredients, particularly of inorganic salts such as carbonates and sulfates, which above a certain temperature have reduced solubilities in the solvent, particularly water, and, accordingly, tend to crystallize out and to deposit on the heat exchanger at the process temperatures. In one preferred embodiment of the invention, therefore, a heat exchanger with wall deposit cleaning devices is used. The direct introduction of pressurized steam as heat source b), however, avoids such deposits from the outset.

Also possible is a combination of direct and indirect introduction of heat. Mention may be made here, by way of example, of the use of a three-stage Supratron, by means of which steam can be fed in and, additionally, heat can be generated by way of the electrical drive. The Supratron has the advantage that, where undissolved particles are present, these particles are very finely ground. This has once again an additional effect on the fine division of the end product: a positive effect, in that the end product is even finer. Any particles regarded as oversize for the purposes of the invention are comminuted. The finer particle size, moreover, reduces the risk of clogging of the spray drying nozzles.

The means b) and/or c) are preferably provided with a mixing device, in particular with a customary dynamic or static mixer, with particular preference with a static mixer, with very particular preference with a jacketed static mixer.

Particularly suitable means d) of the apparatus in the method of the invention include atomizer nozzles, examples being pneumatic atomizer nozzles, hollow cone nozzles, full cone nozzles, flat jet nozzles, full jet nozzles or ultrasonic atomizers.

The temperature prevailing in the means b) to d) depends on the nature of the solvent and of the solvent-containing composition. Since the solvent is particularly water, in that case the temperature in the means b) to d) is over 100° C., in particular in the range from 100° C. to 240° C., with particular preference in the range from 140° C. to 160° C., with very particular preference approximately 150° C.

The overpressure in the means c) and d) is likewise dependent on the nature of the solvent and of the solvent-containing composition. Where water is used as solvent, the overpressure is preferably in the range from about 5 bar to about 60 bar, in particular from about 20 bar to about 50 bar, with particular preference from about 30 bar to about 40 bar.

In the relaxation space e) the prevailing pressure is atmospheric or underpressure, preferably atmospheric pressure.

In one preferred embodiment of the present invention features a) to e) are integrated into a spraying tower. In this embodiment of the present invention the atomized composition is guided in a stream of hot gas, in particular in a stream of superheated steam as hot gas, as described in WO 92/05849, hereby incorporated in full by reference.

In comparison to conventional spray drying processes, the maximum of the particle size distribution is shifted to significantly lower values in the case of products produced by the pressure-release evaporation method of the invention in a spray drier. Moreover, a narrower distribution curve of the direct spray drying products is obtained than in conventional spray drying processes. Without wishing to be tied to this theory, the applicant assumes that, in conventional spray drying processes as in the countercurrent process, in which the atomized droplet to be dried had a relatively high residence time, agglomeration occurs partly as a result of droplet/droplet agglomeration, thereby producing a broader grain size distribution. Normally the droplets have a nozzle exit velocity of at least 50 m/s, preferably above 50 m/s. The solvent, particularly the water, evaporates as a result of the countercurrent air. By this means it becomes clear that an atomized droplet to be dried travels a certain distance—merely by way of example mention may be made here of 0.5 m to 1 m—before the droplet is transformed into a solid particle. Through the pressure-release evaporation method, two critical parameters are modified: firstly the droplets are accelerated, and secondly, corresponding to the temperature difference (the vapor pressure is significantly greater than the ambient pressure), the evaporation of the solvent, particularly of the water, takes place much more quickly, and ideally is immediate. As a result of the fact that particle formation takes place almost directly after exit from the nozzle, the formation of agglomerates—so it is assumed—is prevented or at least substantially suppressed. This theory is favored not only by the relatively uniform grain spectrum of the products of the invention and of products produced in accordance with the invention, but also by the fact that the particle size of the direct spray drying product is the same, within the bounds of normal production accuracy, as the droplet size of the spray jet. Thus in one preferred embodiment of the invention the particle size of the direct spray drying product is set, within the bounds of normal production accuracy, by the droplet size of the spray jet.

In another embodiment the present invention provides an apparatus for the spray drying of solvent-containing, particularly water-containing, compositions, which comprises: a feedline for a liquid or pasty, solvent-containing, particularly water-containing, composition, b) a means for the direct introduction of pressurized steam and also, where appropriate, a means for indirect input of heat, c) means for transporting the liquid or pasty, solvent-containing, particularly water-containing, composition, heated by means of b), under overpressure and at a temperature above the boiling point of the solvent, particularly water, d) means for atomizing the liquid or pasty, solvent-containing, particularly water-containing, composition, heated by means of b) and transported under overpressure by means of c), at a temperature above the boiling point of the solvent, particularly water, and e) a relaxation space which is not under overpressure, and which accommodates the composition atomized by means of d). For elucidation of the apparatus of the invention and its preferred embodiments, reference is made to the description above, it being expressly stated once again that in one preferred embodiment of the present invention the features a) to e) are integrated into a spraying tower.

The direct spray drying product can either be used as an end product or be aftertreated and/or processed further.

In one preferred embodiment of the invention the direct spray drying product is rounded. This can be done in a customary rounder. The rounding time is preferably not longer than 4 minutes, in particular not longer than 3.5 minutes. Rounding times of 1.5 minutes maximum or below are particularly preferred. Rounding increases further the uniformity of the grain spectrum, since any agglomerates formed are comminuted. Direct spray drying products which have been only rounded but not additionally aftertreated in another way preferably have an apparent weight of not more than 500 g/l. Surprisingly it has been found, as a function of the formula of the direct spray drying product, that by the measure of rounding it is possible for the free-flow properties of the product to be impaired significantly. Thus it is possible for the free-flow properties to be impaired to such an extent, by rounding for 1 minute, that in the known free-flow test/hopper test, which is described below, the time taken for the sample to run through can be increased significantly: for example, from 16 seconds to 39 seconds.

Like usual spray drying products, the direct spray drying product can also be processed with further ingredients, which may be solid, liquid and/or pasty in nature.

In one aftertreatment step it is therefore possible for the direct spray drying product to be powdered with a solid, examples being silicas, zeolites, carbonates, bicarbonates and/or sulfates, citrates, urea or mixtures of two or more of the stated constituents, as is well known from the prior art. This can be done either directly after the direct spray drying product has departed the tower, in a mixer, or else, advantageously, in the rounder. It is preferred in this case to use solids, in particular bicarbonate and soda, in amounts of up to 15% by weight and in particular in amounts of from 2 to 15% by weight, based in each case on the aftertreated product. Surprisingly it has been found that the addition of solids, and particularly of bicarbonate, in the rounder can lead to a distinct elevation of the free-flow properties. Thus the abovementioned product, which after a one-minute rounding had a free-flow time of 39 seconds, gave a free-flow time of 17 seconds after a further rounding time of 10 seconds with 5% by weight bicarbonate, based on the aftertreated product; this free-flow time of 17 seconds can be equated, within the bounds of measurement accuracy, to the initial value of 16 seconds for the direct spray drying product without aftertreatment. The apparent weight of this after-treated product was below 400 g/l.

In another preferred embodiment of the invention the direct spray drying product is aftertreated, in particular prior to rounding, with nonionic surfactants, which may for example contain optical brighteners and/or hydrotropes, fragrance, a solution of optical brightener and/or foam inhibitors or preparation forms which may comprise these ingredients. These ingredients or preparation forms comprising these ingredients are preferably applied in liquid, melt or paste form to the direct spray drying product. Advantageously the direct spray drying products are aftertreated with up to 20% by weight, advantageously with from 2 to 18% by weight, and in particular with from 5 to 15% by weight of active substance of said ingredients. The amounts are based in each case on the aftertreated product. It is preferred in this context for the aftertreatment with the substances stated here to take place in a customary mixer, merely by way of example in a twin-shaft mixer over the course of not more than 1 minute, preferably over the course of 30 seconds, and for example over the course of 20 seconds, the times indicated standing simultaneously for addition time and mixing time. Products aftertreated in this way may have an apparent weight of above 500 g/l, from 550 to 700 g/l for example.

It is not surprising to the skilled worker that by aftertreatment with liquid nonionic surfactants it is possible for the free-flow properties of the product to be impaired. Starting from the abovementioned direct spray drying product with a free-flow time of 16 seconds, aftertreatment of this product with 15% by weight, based on the aftertreated product, of C₁₂-C₁₈ fatty alcohol containing 7 EO gave a free-flow time of 63 seconds. In the case of three-minute rounding the apparent weight rose to 580 g/l and the free-flow time to more than 100 seconds.

Nonionic surfactants used are preferably alkoxylated, advantageously ethoxylated, especially primary, alcohols having preferably 8 to 18 carbon atoms and on average from 1 to 12 mol of ethylene oxide (EO) per mole of alcohol, in which the alcohol radical may be linear or, preferably, methyl-branched in position 2 and/or may comprise linear and methyl-branched radicals in a mixture, as are commonly present in oxo alcohol radicals. In particular, however, preference is given to alcohol ethoxylates containing linear radicals from alcohols of natural origin having 12 to 18 carbon atoms, e.g., from coconut, palm, palm kernel, tallow fatty or oleyl alcohol, and on average from 2 to 8 EO per mole of alcohol. Preferred ethoxylated alcohols include, for example, C₁₂-C₁₄ alcohols containing 3 EO or 4 EO, C₉-C₁₁ alcohols containing 7 EO, C₁₃-C₁₅ alcohols containing 3 EO, 5 EO, 7 EO or 8 EO, C₁₂-C₁₈ alcohols containing 3 EO, 5 EO or 7 EO, and mixtures thereof, such as mixtures of C₁₂-C₁₄ alcohol containing 3 EO and C₁₂-C₁₈ alcohol containing 7 EO. The stated degrees of ethoxylation represent statistical mean values, which for a specific product may be an integer or a fraction. Preferred alcohol ethoxylates have a narrowed homolog distribution (narrow range ethoxylates, NREs). In addition to these nonionic surfactants it is also possible to use fatty alcohols containing more than 12 EO. Examples thereof are (tallow) fatty alcohols containing 14 EO, 16 EO, 20 EO, 25 EO, 30 EO or 40 EO.

As further nonionic surfactants, furthermore, use may also be made of alkyl glycosides of the general formula RO(G)ₓ, where R is a primary straight-chain or methyl-branched aliphatic radical, especially an aliphatic radical methyl-branched in position 2, having 8 to 22, preferably 12 to 18, carbon atoms, and G is the symbol representing a glycose unit having 5 or 6 carbon atoms, preferably glucose. The degree of oligomerization, x, which indicates the distribution of monoglycosides and oligoglycosides, is any desired number between 1 and 10; preferably, x is from 1.1 to 1.4.

A further class of nonionic surfactants used with preference, which are used either as sole nonionic surfactant or in combination with other nonionic surfactants, in particular together with alkoxylated fatty alcohols and/or alkyl glycosides, are alkoxylated, preferably ethoxylated, or ethoxylated and propoxylated, fatty acid alkyl esters, preferably having 1 to 4 carbon atoms in the alkyl chain, especially fatty acid methyl esters, as are described, for example, in Japanese patent application JP 58/217598, or those prepared preferably by the process described in international patent application WO-A-90/13533. Particular preference is given to C₁₂-C₁₈ fatty acid methyl esters containing on average from 3 to 15 EO, in particular containing on average from 5 to 12 EO.

Nonionic surfactants of the amine oxide type, examples being N-cocoalkyl-N,N-dimethylamine oxide and N-tallowalkyl-N,N-dihydroxyethylamine oxide, and of the fatty acid alkanolamide type, may also be suitable. The amount of these nonionic surfactants is preferably not more than that of the ethoxylated fatty alcohols, in particular not more than half thereof.

For machine dishwashing, suitable surfactants include in principle all surfactants. Preference for this end use, however, is given to the nonionic surfactants described above, and, of those, in particular to the low-foaming nonionic surfactants. The alkoxylated alcohols are particularly preferred, especially the ethoxylated and/or propoxylated alcohols. By alkoxylated alcohols the skilled worker understands, in general, the reaction products of alkylene oxide, preferably ethylene oxide, with alcohols, preferably, for the purposes of the present invention, the relatively long-chain alcohols (C₁₀ to C₁₈, preferably between C₁₂ and C₁₆, such as C₁₁, C₁₂, C₁₃, C₁₄, C₁₅, C₁₆, C₁₇, and C₁₈ alcohols, for example). Generally speaking, n moles of ethylene oxide and one mole of alcohol produce, depending on the reaction conditions, a complex mixture of addition products differing in degree of ethoxylation. A further embodiment consists in the use of mixtures of the alkylene oxides, preferably of the mixture of ethylene oxide and propylene oxide. A further possibility if desired is to obtain, by a final etherification with short-chain alkyl groups, such as preferably the butyl group, the class of substance of the “capped” alcohol ethoxylates, which can likewise be used for the purposes of the invention. Very particular preference is given in this context, for the purposes of the present invention, to highly ethoxylated fatty alcohols or mixtures thereof with end group-capped fatty alcohol ethoxylates.

As perfume oils and/or fragrances it is possible to use individual odorant compounds, examples being the synthetic products of the ester, ether, aldehyde, ketone, alcohol, and hydrocarbon types. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methylphenylglycinate, allyl cyclohexylpropionate, styrallyl propionate, and benzyl salicylate. The ethers include, for example, benzyl ethyl ether; the aldehydes include, for example, the linear alkanals having 8-18 carbon atoms, citral, citronellal, citronellyloxy-acetaldehyde, cyclamen aldehyde, hydroxycitronellal, lilial, and bourgeonal; the ketones include, for example, the ionones, α-isomethylionone, and methyl cedryl ketone; the alcohols include anethole, citronellol, eugenol, geraniol, linalool, phenylethyl alcohol, and terpineol; the hydrocarbons include primarily the terpenes such as limonene and pinene. Preference, however, is given to the use of mixtures of different odorants which together produce an appealing fragrance note. Such perfume oils may also contain natural odorant mixtures, as are obtainable from plant sources, examples being pine oil, citrus oil, jasmine oil, patchouli oil, rose oil or ylang-ylang oil. Likewise suitable are muscatel, sage oil, camomile oil, clove oil, balm oil, mint oil, cinnamon leaf oil, lime blossom oil, juniperberry oil, vetiver oil, olibanum oil, galbanum oil, and labdanum oil, and also orange blossom oil, neroliol, orange peel oil, and sandalwood oil.

Further suitable additions are foam inhibitors such as, for example, foam-inhibiting paraffin oil or foam-inhibiting silicone oil, dimethylpolysiloxane for example. Also possible is the use of mixtures of these active substances. Suitable additives which are solid at room temperature, particularly in the case of the stated foam-inhibiting active substances, include paraffin waxes, silicas, which may also be conventionally hydrophobicized, and bisamides derived from C₂₋₇ diamines and C₁₂₋₂₂ carboxylic acids.

Foam-inhibiting paraffin oils suitable for use, which may be present as a blend with paraffin waxes, are generally complex mixtures of substances without a defined melting point. For their characterization, the melting range is usually determined by means of differential thermoanalysis (DTA), as described in “The Analyst” 87 (1962), 420, and/or the solidification point. By this is meant the temperature at which the paraffin undergoes the transition from the liquid state to the solid state by slow cooling. Paraffins having less than 17 carbon atoms cannot be used in accordance with the invention, and their fraction in the paraffin oil mixture ought therefore to be as low as possible, and is preferably below the limit which can be measured significantly by customary analytic methods, gas chromatography for example. It is preferred to use paraffins which solidify in the range from 20° C. to 70° C. It should be borne in mind here that even paraffin wax mixtures which appear solid at room temperature may contain different fractions of liquid paraffin oils. In the case of the paraffin waxes which can be used in accordance with the invention the liquid fraction at 40° C. is as high as possible, without already amounting to 100% at this temperature. Preferred paraffin wax mixtures have at 40° C. a liquid fraction of at least 50% by weight, in particular from 55% by weight to 80% by weight, and at 60° C. have a liquid fraction of at least 90% by weight. As a result of this the paraffins are fluid and pumpable at temperatures down to at least 70° C., preferably down to at least 60° C. It should further be ensured that the paraffins as far as possible contain no volatile fractions. Preferred paraffin waxes contain less than 1% by weight, in particular less than 0.5% by weight, of fractions which can be evaporated at 110° C. under atmospheric pressure. Paraffins which can be used in accordance with the invention can be acquired, for example, under the commercial designations Lunaflex® from Fuller and Deawax® from DEA Mineralöl AG.

The paraffin oils may comprise bisamides which are solid at room temperature and derive from saturated fatty acids having 12 to 22, preferably 14 to 18, carbon atoms and also from alkylene diamines having 2 to 7 carbon atoms. Suitable fatty acids are lauric, myristic, stearic, arachidic, and behenic acid, and also mixtures thereof, such as are obtainable from natural fats or hydrogenated oils, such as tallow or hydrogenated palm oil. Examples of suitable diamines include ethylenediamine 1,3-propylenediamine, tetramethylenediamine, pentamethylenediamine, hexamethylenediamine, p-phenylenediamine, and tolylenediamine. Preferred diamines are ethylenediamine and hexamethylenediamine. Particularly preferred bisamides are bismyristoylethylenediamine, bispalmitoylethylenediamine, bisstearoylethylenediamine, and mixtures thereof, and also the corresponding derivatives of hexamethylenediamine.

In certain embodiments of the invention the stated foam inhibitors may also be present in the direct spray drying product.

In a further embodiment of the invention the product aftertreated with the stated ingredients and optionally rounded is aftertreated with solids, preferably bicarbonate and/or soda, in particular in amounts of from 2 to 15% by weight, based on the aftertreated product. Here again, aftertreatment with the solids takes place advantageously in a rounder. Surprisingly it has been possible, by adding 11% by weight, based on the aftertreated product, of bicarbonate in the rounder and by rounding further for 10 seconds, to convert the highly tacky product aftertreated with nonionic surfactant and in a rounder to a product which has an apparent weight of 716 g/l and a free-flow time of only 22 seconds.

As a result of the indicated aftertreatment measures of rounding, treatment with liquid to pasty and/or solid ingredients with or without rounding, it is possible to obtain a series of aftertreated products having good free-flow properties and a broad apparent weight spectrum. Products aftertreated in this way advantageously have an apparent weight of from 380 g/l to 950 g/l, preferably from 400 to 750 g/l, and in particular from 450 g/l to 740 g/l: for example, from 580 g/l to 740 g/l. Particular preference, however, is given to compositions of this kind which have apparent weights of from 450 to 600 g/l, very particular preference attaching to apparent weights of up to 550 g/l. Depending on the demands of the application the apparent weight can be adjusted by means of the corresponding measures, therefore, without significantly impairing the free-flow properties or the grain size distribution.

The compositions of the invention and compositions produced in accordance with the invention also have the advantage of being rapidly soluble.

In a further embodiment of the invention the direct spray drying products and/or the above-described aftertreated products can be processed, in particular by mixing, with further constituents of laundry detergents or cleaning products, it being advantageous that it is possible to admix constituents which are not amenable to spray drying. From the broad state of the art it is common knowledge which ingredients of detergents or cleaning products are not amenable to spray drying and which raw materials are usually admixed. Reference is made to these general literature passages. Listed in more detail are only high-temperature-sensitive, customary mixing constituents of detergents or cleaning products, such as bleaches based on per compounds, bleach activators and/or bleaching catalysts, enzymes from the class of the proteases, lipases, and amylases; and/or bacteria strains or fungi, foam inhibitors in optionally granular and/or compounded form, perfumes, temperature-sensitive dyes and the like, which advantageously are mixed with the compositions, dried beforehand, and with optionally aftertreated products.

Ingredients which can likewise be admixed subsequently include UV absorbers, which attach to the treated textiles and improve the light stability of the fibers and/or the light stability of other formulation constituents. By UV absorbers are meant organic substances (light protection filters) which are able to absorb ultraviolet radiation and to emit the absorbed energy again in the form of radiation of longer wavelength, e.g., heat. Compounds which possess these desired properties are, for example, the compounds of benzophenone, which are active by radiationless deactivation and derivatives of benzophenones having substituents in position 2 and/or 4. Also suitable, furthermore, are substituted benzotriazoles, acrylates phenyl-substituted in position 3 (cinnamic acid derivatives), with or without cyano groups in position 2, salicylates, organic Ni complexes, and natural substances such as umbelliferone and the endogenous urocanic acid. Particular importance is possessed by biphenyl derivatives and, in particular, stilbene derivatives as described, for example, in EP 0728749 A and available commercially as Tinosorb® FD or Tinosorb® FR from Ciba. As UV-B absorbers mention may be made of 3-benzylidenecamphor or 3-benzylidenenorcamphor and its derivatives, e.g., 3-(4-methylbenzylidene)camphor, as described in EP 0693471 B1; 4-aminobenzoic acid derivatives, preferably 2-ethylhexyl 4-(dimethyl-amino)benzoate, 2-octyl 4-(dimethylamino)benzoate, and amyl 4-(dimethylamino)benzoate; esters of cinnamic acid, preferably 2-ethylhexyl 4-methoxycinnamate, propyl 4-methoxycinnamate, isoamyl 4-methoxycinnamate, 2-ethylhexyl 2-cyano-3,3-phenylcinnamate (octocrylenes); esters of salicylic acid, preferably 2-ethylhexyl salicylate, 4-isopropylbenzyl salicylate, homomenthyl salicylate; derivatives of benzophenone, preferably 2-hydroxy-4-methoxybenzophenone, 2-hydroxy-4-methoxy-4′-methylbenzophenone, 2,2′-dihydroxy-4-methoxybenzophenone; esters of benzalmalonic acid, preferably di-2-ethylhexyl 4-methoxybenzmalonate; triazine derivatives, such as 2,4,6-trianilino(p-carbo-2′-ethyl-1′-hexyloxy)-1,3,5-triazine and Octyl Triazone, as described in EP 0818450 A1, or Dioctyl Butamido Triazone (Uvasorb® HEB); propane-1,3-diones, such as 1-(4-tert-butylphenyl)-3-(4′-methoxyphenyl)propane-1,3-dione, for example; ketotricyclo[5.2.1.0]decane derivatives, as described in EP 0694521 B1. Of further suitability are 2-phenylbenzimidazole-5-sulfonic acid and the alkali metal, alkaline earth metal, ammonium, alkylammonium, alkanolammonium, and glucammonium salts thereof; sulfonic acid derivatives of benzophenones, preferably 2-hydroxy-4-methoxybenzophenone-5-sulfonic acid and its salts; sulfonic acid derivatives of 3-benzylidenecamphor, such as 4-(2-oxo-3-bornylidenemethyl)benzenesulfonic acid and 2-methyl-5-(2-oxo-3-bornylidene)sulfonic acid, and salts thereof.

As typical UV-A filters, suitability is possessed in particular by derivatives of benzoylmethane, such as, for example, 1-(4′-tert-butylphenyl)-3-(4′-methoxyphenyl)propane-1,3-dione, 4-tert-butyl-4′-methoxydibenzoylmethane (Parsol 1789), 1-phenyl-3-(4′-isopropylphenyl)propane-1,3-dione, and enamine compounds, as described in DE 19712033 A1 (BASF). The UV-A and UV-B filters can of course also be used in mixtures. Besides the stated soluble substances, insoluble light protection pigments as well are suitable for this purpose, namely finely disperse, preferably nanoized, metal oxides and/or salts. Examples of suitable metal oxides are, in particular, zinc oxide and titanium dioxide and, in addition, oxides of iron, of zirconium, of silicon, of manganese, of aluminum, and of cerium, and also mixtures thereof. Salts which can be used include silicates (talc), barium sulfate or zinc stearate. The oxides and salts are already used, in the form of a pigment, for skincare emulsions, skin protection emulsions, and decorative cosmetics. The particles ought to have an average diameter of less than 100 nm, preferably between 5 and 50 nm, and in particular between 15 and 30 nm. They may have a spherical form, although it is also possible to employ particles which possess a form which is ellipsoidal or which otherwise deviates from the spherical. The pigments may also be in surface-treated form, i.e., hydrophilicized or hydrophobicized. Typical examples are coated titanium dioxides, such as titanium dioxide T 805 (Degussa) or Eusolex® T2000 (Merck), for example. Suitable hydrophobic coating agents in this case include, in particular, silicones, and especially trialkoxyoctylsilanes or simethicones. It is preferred to use micronized zinc oxide. Further suitable UV light protection filters can be found in the review by P. Finkel in SÖFW-Journal 122, 543 (1996).

The UV absorbers are used usually in amounts of from 0.01% by weight to 5% by weight, preferably from 0.03% by weight to 1% by weight. In exceptional cases they may also be present in the direct spray drying product.

It is possible, however, to include also other constituents, so-called speckles, for example, which contrast in their color and/or their shape from the appearance of the direct and/or aftertreated spray drying products. The speckles may on the one hand have a grain spectrum similar or identical to that of the direct and/or aftertreated spray drying products, and also the same composition, but a different color. Secondly it is possible for the speckles to have the same composition as the direct and/or aftertreated spray drying products, be not colored, but to have a different shape. Ultimately it is preferred, however, for speckles which have the same composition as the direct and/or aftertreated spray drying products to differ from the latter in their color and additionally, where appropriate, in their shape. In these cases the speckles are merely intended to contribute to making the appearance of the finished detergent or cleaning products even more attractive.

In a further and entirely preferred embodiment of the invention, nevertheless, the speckles have a different chemical composition than the direct and/or aftertreated spray drying products. Here in particular it is possible on the basis of a different color and/or a different shape to indicate to the end user that certain ingredients are present for certain purposes: bleaching or care aspects in the end product, for example. These speckles can not only have a shape ranging from spherical to rodletlike, they may also represent entirely different figures. At this point reference is made to the disklosure content of the international applications WO 97/08290 and WO 00/23556.

The admixed speckles or else other ingredients can, for example, be spray dried, agglomerated, granulated, pelletized or extruded. With respect to extrusion processes, reference is made here in particular to the disklosure contents in European Patent EP 0486592 B1 and the international patent application WO 98/12299. Since it is an advantage of the direct and/or inventively aftertreated spray drying products that they comprise an outstanding dissolution rate even in the case of relatively cold water at 30° C., it is of course preferred to admix such products with further ingredients and/or raw materials of a kind which likewise exhibit an outstanding dissolution rate. In one preferred embodiment of the invention, therefore, raw materials are admixed which have been produced in accordance with the disklosure content of international patent application WO 99/28433.

In a further embodiment, therefore, the present invention provides a detergent or cleaning product that comprises at least one direct spray drying product of the invention and/or product aftertreated in accordance with the invention, in particular in amounts of from 5 to 90% by weight, and also admixed constituents. Although the apparent weight of the ready-processed compositions may also be higher, it is nevertheless preferred in the context of the present invention for the compositions thus processed to have an apparent weight of not more than 700 g/l and in particular below, for example, not more than 680 g/l or even not more than 650 g/l.

Free-flow Test/hopper Test For determination of the free-flow characteristics, 1 liter of each sample under measurement was introduced into a powder hopper, which to start with was closed off in its outflow direction, and then the outflow time of the samples was measured. The outflow time of dry marine sand after the outflow opening is released (13 seconds) was taken as the reference value.

Aggregation Test For this test, 15 ml of the respective composition were measured off into a 25 ml graduated cylinder and transferred to a stainless steel cylinder which stood in a porcelain dish or the like. Then, without the powder being compressed, a stainless steel die was inserted in the cylinder and loaded with a weight of 500 g. After 30 minutes the weight was removed, the cylinder was raised, and the composition was pressed out using the die. The scores are awarded in principle as follows: if the compact falls apart as it is being pressed out, then the aggregation test is scored with “0”. Otherwise, a vessel is placed on the dish with the compact, and water is introduced into this vessel until the compact breaks up. The amount of water required, in grams, is stated as the aggregation test score. In the context of the present invention, scores of more than 30 are found unacceptable and the compositions are regarded as no longer free-flowing.

Determination of the Dry Residue For the determination of the dry residue a defined sample quantity of the product under investigation is dried in an aluminum tray in a preheated drying oven at 130° C. for 30 minutes. The quotient formed from the amount of the residue after drying in relation to the amount of sample introduced prior to drying, multiplied by 100, gives the dry residue in %. The difference between this figure and 100 indicates the value for the amount of moisture lost by drying under these conditions. The test is repeated a number of times (about 3 to 5 times) and subsequently the mean value for the dry residue is calculated.

What is claimed is:

1. A particulate detergent or cleaning product comprising a direct spray drying product that has an apparent weight in the range from 220 g/l to 500 g/l and a particle diameter d50 in the range from 0.12 mm to 0.6 mm.

2. The composition of claim 1, being free-flowing and having an aggregation test score of less than 30.

3. The composition of claim 2, having an aggregation test score of less than 20.

4. The composition of claim 3, having an aggregation test score of less than 10.

5. The composition of claim 4, having an aggregation test score of less than 5.

6. The composition of claim 1, comprising a builder system, the builder system comprising one or more inorganic and/or organic builders and/or cobuilders, and being predominantly water-soluble.

7. The composition of claim 6, wherein at least 60% by weight of the builder system is water soluble.

8. The composition of claim 7, wherein at least 70% by weight of the builder system is water soluble.

9. The composition of claim 8, wherein 75 to 100% by weight of the builder system is water soluble.

10. A detergent or cleaning product, comprising a surfactant, an inorganic builder substance, and optionally an organic builder substance, the product being in the form of a direct spray drying product, wherein the inorganic builder substance is predominantly water-soluble.

11. The composition of claim 10, wherein the particle diameter d50 is 0.12 mm to 0.6 mm.

12. The composition of claim 10, wherein the particle diameter d50 is 0.14 mm to 0.6 mm.

13. The composition of claim 10, having an apparent weight in the range from 220 g/l to 500 g/l.

14. The composition of claim 10, being free-flowing and having an aggregation test score of less than 30.

15. The composition of claim 14, having an aggregation test score of less than 20.

16. The composition of claim 15, having an aggregation test score of less than 10.

17. The composition of claim 16, having an aggregation test score of less than 5.

18. The composition of claim 1, having a dry residue of 94.5 to 99.8%.

19. The composition of claim 18, having a dry residue of 95.2 to 99.2%.

20. The composition of claim 19, having a dry residue of 96.0 to 98.5%.

21. The composition of claim 1, wherein the particle diameter d50 is 0.17 mm to 0.4 mm.

22. The composition of claim 21, wherein the particle diameter d50 is 0.19 mm to 0.28 mm.

23. The composition of claim 1, having a particle diameter d90 of 0.3 mm to 0.8 mm.

24. The composition of claim 23, having a particle diameter d90 of 0.35 mm to 0.55 mm.

25. The composition of claim 1, having a particle diameter d10 of not more than 0.2 mm.

26. The composition of claim 25, having a particle diameter d10 of 0.12 mm to 0.18 mm.

27. The composition of claim 1, wherein not more than 5% by weight has a particle size below 0.1 mm.

28. The composition of claim 1, having an apparent weight of 250 g/l to 480 g/l.

29. The composition of claim 28, having an apparent weight of 300 to 450 g/l.

30. The composition of claim 10, having an apparent weight of 400 to 750 g/l.

31. The composition of claim 30, having an apparent weight of 450 to 600 g/l.

32. The composition of claim 31, having an apparent weight of 450 to 550 g/l.

33. The composition of claim 1, wherein the particles are rounded.

34. The composition of claim 1, comprising in combination up to 20% by weight of one or more a nonionic surfactant, a fragrance, and/or a foam inhibitor.

35. The composition of claim 34, comprising in combination 2 to 18% by weight of one or more a nonionic surfactant, a fragrance, and/or a foam inhibitor.

36. A method of producing a fine-grained detergent or cleaning product, comprising the steps of:
a) heating a liquid or pasty, solvent-containing composition to a temperature above the boiling point of the solvent, the heating being direct, indirect, or both;
b) supplying the heated composition at excess pressure and temperature to an atomizing device; and
c) atomizing the heated composition into a relaxation space that is not at excess pressure to form a particulate product that has an apparent weight in the range from 220 g/l to 500 g/l and a particle diameter d50 in the range from 0.12 mm to 0.6 mm.

37. The method of claim 36, wherein the composition in a) is heated to at least 100° C.

38. The method of claim 37, wherein the composition in a) is heated to at least 130° C.

39. The method of claim 38, wherein the composition in a) is heated to at least 160° C.

40. The method of claim 36, wherein the atomized composition is dried with air, air/flue gas mixtures, nitrogen, and/or superheated steam as a drying gas.

41. The method of claim 40, wherein the composition is dried to a dry residue of 94.5 to 99.8%.

42. The method of claim 41, wherein the composition is dried to a dry residue of 95.2 to 99.2%.

43. The method of claim 42, wherein the composition is dried to a dry residue of 96.0 to 98.5%.

44. The method of claim 36, wherein the composition in a) is heated by means of a heat exchanger.

45. The method of claim 36, wherein the composition in a) is heated by means of direct introduction of pressurized steam by a venturi.

46. The method of claim 45, wherein the direct introduction of steam takes place with a steam pressure of 20 to 75 bar.

47. The method of claims 36, wherein the particle size of the particulate product is adjusted by the atomizing step.

48. The method of claim 36, wherein the particulate product is aftertreated in a rounder.

49. The method of claim 48, wherein the aftertreatment step is not longer than 4 minutes.
